(19) United States
(12) Patent Application Publication
(10) Pub. No.: US 2006/0127138 A1
(43) Pub. Date: Jun. 15, 2006

(54) Semiconductive endless belt and electrophotographic apparatus

(75) Inventor: Noriaki Egawa, Yokohama-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/299,990

(22) Filed: Dec. 12, 2005

(30) Foreign Application Priority Data
Dec. 10, 2004 (JP) 2004-358100

(51) Int. Cl. G03G 15/16; G03G 15/20

(52) U.S. Cl. 399/297; 428/141; 399/308

(57) ABSTRACT

A semiconductive endless belt formed of a resin composition containing a resin capable of being formed into a film only by removing a solvent from a resin solution, and having a pencil hardness of 3H or more according to JIS K 5400 and a refractive index of 1.75 or more for light having a wavelength of 900 μm. Also disclosed is an electrophotographic apparatus having this semiconductive endless belt.

### BACKGROUND OF THE INVENTION

1. Field of the Invention

This invention relates to a semiconductive endless belt, in particular, a transfer material transport belt and an intermediate transfer belt, used in image forming apparatus such as electrophotographic apparatus and electrostatic recording apparatus. This invention also relates to an electrophotographic apparatus having such a semiconductive endless belt.

2. Related Background Art

Among image forming apparatus employing an electrophotographic system, i.e., electrophotographic apparatus, color electrophotographic apparatus which form multi-color images (color images) often make use of semiconductive endless belts such as a transfer material transport belt and an intermediate transfer belt.

As the semiconductive endless belts, commonly available are those composed of a resin composition prepared by compounding a resin with a conducting agent. This conducting agent may include conductive fillers such as carbon black and KETJEN BLACK, and conducting agents having ionic conductivity.

In general, positional adjustment and density adjustment of images are made by utilizing the reflection of light (chiefly, infrared light) applied to patch images formed on the surface of an endless belt (see, e.g., Japanese Patent Application Laid-Open No. 2003-162117). The semiconductive endless belts such as a transfer material transport belt and an intermediate transfer belt are required that the reflectance of the light on their surfaces are higher than that of the patch images and that this reflectance is small in changes with time.

The change with time of the reflectance at the surface of an endless belt is caused by the wearing of endless-belt surface or the scratching of endless-belt surface as a result of the repeated friction of the endless belt with a developer, a cleaning member, a transfer material and so forth. Accordingly, the semiconductive endless belt is also required to have high wear resistance and scratch resistance.

As a resin used in the semiconductive endless belt, an example in which a non-thermoplastic polyimide resin is used is disclosed in, e.g., Japanese Patent Application Laid-Open No. H05-077252). The use of a non-thermoplastic resin such as the non-thermoplastic polyimide resin enables production of a semiconductive endless belt having high wear resistance and scratch resistance.

However, where the semiconductive endless belt is produced using such a non-thermoplastic resin, it is difficult to form the non-thermoplastic resin into films only by removing a solvent from a resin solution, and hence a step which involves chemical reaction, such as a heat dehydration reaction step, must be provided. The step which involves chemical reaction is complicate in the step itself and also requires strict and complicate temperature control, and hence the semiconductive endless belt obtained using the non-thermoplastic resin must result in a high cost.

### SUMMARY OF THE INVENTION

An object of the present invention is to provide at a low cost a semiconductive endless belt which has high wear resistance and scratch resistance, has high reflectance, and may undergo small changes with time in respect of this reflectance, and an electrophotographic apparatus having such a semiconductive endless belt.

That is, the present invention is a semiconductive endless belt comprising a resin composition containing a resin capable of being formed into a film only by removing a solvent from a resin solution, and having a pencil hardness of 3H or more according to JIS K 5400 and a refractive index of 1.75 or more for light having a wavelength of 900 μm.

The present invention is also an electrophotographic apparatus having the above semiconductive endless belt.

### BRIEF DESCRIPTION OF THE DRAWINGS

FIG. 1 is a schematic view showing an example of the construction of an electrophotographic apparatus (color electrophotographic apparatus) in which the semiconductive endless belt of the present invention is used as a transfer material transport belt.

FIG. 2 is a schematic view showing an example of the construction of an electrophotographic apparatus (color electrophotographic apparatus) in which the semiconductive endless belt of the present invention is used as an intermediate transfer belt.

### DESCRIPTION OF THE PREFERRED EMBODIMENTS

As stated previously, it is common that the positional adjustment and density adjustment of images are made by utilizing the reflection of light applied to patch images formed on the surface of an endless belt. Stated specifically, the light reflecting from the patch images is detected with a sensor to lead out the positions and densities of the patch images, and these are fed back to process forming conditions such as applied voltage and laser power to make the positional adjustment and density adjustment of images (adjustment of maximum density of each color and adjustment of halftone gradation). As the light used, it is common to use infrared light having a wavelength of about 900 μm (in the range of 760 to 1,000 μm).

Accordingly, it is preferable that the reflectance of light at the surface of the semiconductive endless belt is higher than that at the patch images, and stated specifically that the reflectance of the light having a wavelength of 900 μm is 6% or more. In order to achieve this reflectance, the semiconductive endless belt of the present invention is prescribed to be one whose refractive index for the light having a wavelength of 900 μm is 1.75 or more (hereinafter the “refractive index for the light having a wavelength of 900 μm” is also simply “refractive index”). Also, from the same viewpoint as this, the semiconductive endless belt may preferably have a surface roughness Ra of 1.0 μm or less. On the other hand, the semiconductive endless belt may preferably have a refractive index of 2.1 or less, and also the semiconductive endless belt may preferably have a surface roughness Ra of 0.01 μm or more from the viewpoint of preventing any tack between the semiconductive endless belt and members coming into contact with it.

It is also preferable that the change with time of the reflectance is small, and stated specifically that the rate of fall in reflectance is within 20%. In order to prevent changes with time of the reflectance, the semiconductive endless belt of the present invention is prescribed to be one having a pencil hardness of 3H or more according to JIS K 5400 (hereinafter the “pencil hardness according to JIS K 5400” is also simply “pencil hardness”). On the other hand, the semiconductive endless belt may preferably have a pencil hardness of 5H or less from the viewpoint of flexing resistance of the semiconductive endless belt.

The semiconductive endless belt of the present invention also makes use of a “resin capable of being formed into a film only by removing a solvent from a resin solution” from the viewpoint of cost reduction. This “resin capable of being formed into a film only by removing a solvent from a resin solution” may include, e.g., various kinds of thermoplastic resins. Also, of the various kinds of thermoplastic resins, aromatic polyamide resins are preferred from the viewpoint of making the semiconductive endless belt have the pencil hardness of 3H or more and the refractive index of 1.75 or more.

In the present invention, the aromatic polyamide resins are meant to be resins having an amide linkage (—NH—CO—) and an aromatic ring in the backbone chain. The aromatic polyamide resins may include, e.g., poly(para-phenyleneterephthalamide). The poly(para-phenyleneterephthalamide) is available as TWARON (trade name) from Teijin Twaron BV, and MICTRON (trade name) from Toray Industries, Inc.

The semiconductive endless belt of the present invention is semiconductive in order to prevent any charge-up from occurring during image formation, and, stated specifically, may preferably have a volume resistivity of 1×10¹¹ Ωcm or less, and more preferably 1×10⁹ Ωcm or less. On the other hand, the semiconductive endless belt of the present invention may preferably have a volume resistivity of 1×10⁶ Ωcm or more, more preferably 1×10⁷ Ωcm or more, and still more preferably 1×10⁸ Ωcm or more.

The conductivity of the semiconductive endless belt may be controlled (i.e., the semiconductive endless belt may be provided with conductivity) by adding a conductive filler to the resin composition used in the semiconductive endless belt.

Such a conductive filler may include, e.g., carbon type fillers, metal type conductive fillers and metal oxide type conductive fillers. Of these, carbon type fillers are preferred. The carbon type fillers may include, e.g., carbon black and carbon fiber. Of these, carbon black is preferred. As types of the carbon black, it may include, e.g., as preferred ones, carbon nanotubes, KETJEN BLACK, acetylene black, furnace black and channel black.

The flexing resistance of the semiconductive endless belt tends to be higher as the conductive filler is in a lower content. From the viewpoint of this, the conductive filler may preferably be in a content of 40% by weight or less, and more preferably 30% by weight or less, based on the total weight of the resin composition used in the semiconductive endless belt.

An electrophotographic apparatus having the semiconductive endless belt of the present invention is described next.

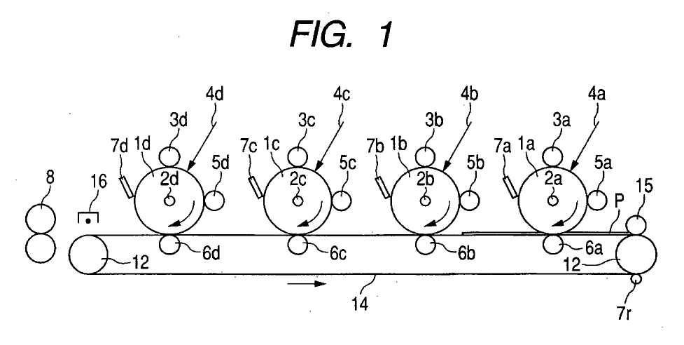

FIG. 1 schematically shows an example of the construction of an electrophotographic apparatus (color electrophotographic apparatus) in which the semiconductive endless belt of the present invention is used as a transfer material transport belt.

In FIG. 1, reference numerals 1a, 1b, 1c and 1d denote cylindrical (drum-shaped) electrophotographic photosensitive members (electrophotographic photosensitive members for first color to fourth color), which are rotatingly driven around axes 2a, 2b, 2c and 2d, respectively, in the directions of arrows at a stated peripheral speed each.

The surface of the electrophotographic photosensitive member 1a for first color which is rotatingly driven is uniformly electrostatically charged to a positive or negative, given potential through a charging means 3a for first color (primary charging means 3a for first color). The electrophotographic photosensitive member thus charged is then exposed to exposure light (imagewise exposure light) 4a emitted from an exposure means (not shown) for slit exposure, laser beam scanning exposure or the like. The exposure light 4a is exposure light corresponding to a first-color component image of an intended color image. In this way, first-color component electrostatic latent images corresponding to the first-color component image of the intended color image are successively formed on the surface of the electrophotographic photosensitive member 1a for first color.

A transfer material transport belt 14 stretched by stretch-over rollers 12 are rotatingly driven in the direction of an arrow at substantially the same peripheral speed as the electrophotographic photosensitive members 1a, 1b, 1c and 1d for first color to fourth color (e.g., 97% to 103% in respect to the peripheral speed of each of the electrophotographic photosensitive members 1a, 1b, 1c and 1d for first color to fourth color). Also, a transfer material (such as paper) P fed from a transfer material feed means (not shown) is electrostatically held on (attracted to) the transfer material transport belt 14, and is successively transported to the parts (contact zones) between the electrophotographic photosensitive members 1a, 1b, 1c and 1d for first color to fourth color and the transfer material transport belt 14.

The first-color component electrostatic latent images thus formed on the surface of the electrophotographic photosensitive member 1a for first color are developed with a first-color toner contained in a developer held by a developing means 5a for first color to form first-color toner images. Then, the first-color toner images thus formed and held on the surface of the electrophotographic photosensitive member 1a for first color are successively transferred by the aid of a transfer bias applied from a transfer member 6a for first color (transfer roller for first color), which are transferred on to a transfer material P held on the transfer material transport belt 14 which passes through between the electrophotographic photosensitive member 1a for first color and the transfer member 6a for first color.

The surface of the electrophotographic photosensitive member 1a for first color from which the first-color toner images have been transferred is brought to removal of the transfer residual developer (toner) through a cleaning means 7a for first color (cleaning blade for first color). Thus, the surface is cleaned, and thereafter the electrophotographic photosensitive member 1a for first color is repeatedly used for the formation of the first-color toner images.

The electrophotographic photosensitive member 1a for first color, the charging means 3a for first color, the exposure means for first color, the developing means 5a for first color and the transfer member 6a for first color are collectively called an image forming section for first color.

An image forming section for second color which has an electrophotographic photosensitive member 1b for second color, a charging means 3b for second color, an exposure means for second color, a developing means 5b for second color and a transfer member 6b for second color, an image forming section for third color which has an electrophotographic photosensitive member 1c for third color, a charging means 3c for third color, an exposure means for third color, a developing means 5c for third color and a transfer member 6c for third color, and an image forming section for fourth color which has an electrophotographic photosensitive member 1d for fourth color, a charging means 3d for fourth color, an exposure means for fourth color, a developing means 5d for fourth color and a transfer member 6d for fourth color are operated in the same way as the operation of the image forming section for first color. Thus, second-color toner images, third-color toner images and fourth-color toner images are transferred on in order, to the transfer material P which is held on the transfer material transport belt 14 and to which the first-color toner images have been transferred. In this way, synthesized toner images corresponding to the intended color image are formed on the transfer material P held on the transfer material transport belt 14.

The transfer material P on which the synthesized toner images have been formed is separated from the surface of the transfer material transport belt 14, is guided into a fixing means 8, where the toner images are fixed, and is then put out of the apparatus as a color-image-formed material (a print or a copy).

The surfaces of the electrophotographic photosensitive members 1a, 1b, 1c and 1d for first color to fourth color from which the transfer residual developers (toners) have been removed by the cleaning means 7a, 7b, 7c and 7d, respectively, may also be subjected to charge elimination by pre-exposure light emitted from pre-exposure means. However, where as shown in FIG. 1 the charging means 3a, 3b, 3c and 3d for first color to fourth color are contact charging means making use of charging rollers or the like, the pre-exposure is not necessarily required.

Incidentally, in FIG. 1, reference numeral 15 denotes an attraction roller for attracting the transfer material to the transfer material transport belt; and 16, a separation charging assembly for separating the transfer material from the transfer material transport belt.

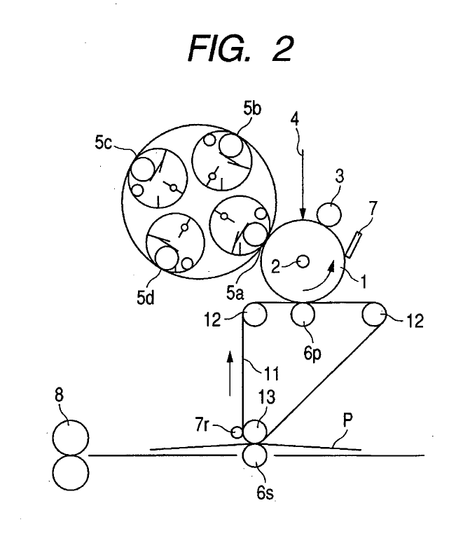

FIG. 2 schematically shows an example of the construction of an electrophotographic apparatus (color electrophotographic apparatus) in which the semiconductive endless belt of the present invention is used as an intermediate transfer belt.

In FIG. 2, reference numeral 1 denotes a cylindrical (drum-shaped) electrophotographic photosensitive member, which is rotatingly driven around an axis 2 in the direction of an arrow at a stated peripheral speed.

The surface of the electrophotographic photosensitive member 1 rotatingly driven is uniformly electrostatically charged on its surface to a positive or negative, stated potential through a charging means (primary charging means) 3. The photosensitive member thus charged is then exposed to exposure light (imagewise exposure light) 4 emitted from an exposure means (not shown) for slit exposure, laser beam scanning exposure or the like. The exposure light used here is exposure light corresponding to a first-color component image of an intended color image. Thus, on the surface of the electrophotographic photosensitive member 1, first-color component electrostatic latent images are successively formed which correspond to the first-color component image of the intended color image.

An intermediate transfer belt 11 stretched over stretch-over rollers 12 and a secondary transfer opposing roller 13 is rotatingly driven in the direction of an arrow at substantially the same peripheral speed as the electrophotographic photosensitive member 1 (e.g., at a speed of 97 to 103% in respect to the peripheral speed of the electrophotographic photosensitive member 1).

The first-color component electrostatic latent images formed on the surface of the electrophotographic photosensitive member 1 are developed with a first-color toner contained in a developer held by a first-color developing means 5a, to form a first-color toner image. Then, the first-color toner images formed and held on the surface of the electrophotographic photosensitive member 1 are successively primarily transferred on to the surface of the intermediate transfer belt 11 passing through between the electrophotographic photosensitive member 1 and a primary transfer member (primary transfer roller) 6p, by the aid of a primary transfer bias applied from the primary transfer member 6p.

The surface of the electrophotographic photosensitive member 1 from which the first-color toner images have been transferred is cleaned by a cleaning means 7 to remove primary transfer residual developer (toner) to make the surface clean. Thereafter, the photosensitive member thus cleaned is used for the next-color image formation.

Second-color toner images, third-color toner images and fourth-color toner images are also formed on the surface of the electrophotographic photosensitive member 1 and then sequentially primarily transferred to the surface of the intermediate transfer belt 11, in the same manner as the first-color toner images. Thus, synthesized toner images corresponding to the intended color image are formed on the surface of the intermediate transfer belt 11. In the course of the first-color to fourth-color primary transfer, a secondary transfer member (secondary transfer roller) 6s and a charge providing means (charge providing roller) 7r stand separate from the surface of the intermediate transfer belt 11.

The synthesized toner images formed on the surface of the intermediate transfer belt 11 are successively secondarily transferred on to a transfer material (such as paper) P by the aid of a secondary transfer bias applied from the secondary transfer member 6s; the transfer material P being taken out and fed from a transfer material feeding means (not shown) to the part (contact zone) between the secondary transfer opposing roller 13/intermediate transfer belt 11 and the secondary transfer member 6s in the manner synchronized with the rotation of the intermediate transfer belt 11.

The transfer material P to which the synthesized toner images have been transferred is separated from the surface of the intermediate transfer belt 11 and guided into a fixing means 8, where the synthesized toner images are fixed, and is then put out of the apparatus as a color-image-formed material (a print or a copy).

The charge providing means 7r is brought into contact with the surface of the intermediate transfer belt 11 from which the synthesized toner images have been transferred. The charge providing means 7r provides the secondary transfer residual developers (toners) held on the surface of the intermediate transfer belt 11, with electric charges having a polarity reverse to that at the time of primary transfer. The secondary transfer residual developers (toners) having been provided with electric charges having the polarity reverse to that at the time of primary transfer are electrostatically transferred to the surface of the electrophotographic photosensitive member 1 at the contact zone between the electrophotographic photosensitive member 1 and the intermediate transfer belt 11 and the vicinity thereof. Thus, the surface of the intermediate transfer belt 11 from which the synthesized toner images have been transferred is cleaned by the removal of the transfer residual developers (toners). The secondary transfer residual developers (toners) having been transferred to the surface of the electrophotographic photosensitive member 1 are removed by the cleaning means 7 together with the primary transfer residual developers (toners) held on the surface of the electrophotographic photosensitive member 1. The transfer of the secondary transfer residual developers (toners) from the intermediate transfer belt 11 to the electrophotographic photosensitive member 1 can be performed simultaneously with the primary transfer, and hence the though-put does not lower.

The surface of the electrophotographic photosensitive member 1 from which the transfer residual developers (toners) have been removed by the cleaning means 7 may also be subjected to charge elimination by pre-exposure light emitted from a pre-exposure means. However, where as shown in FIG. 2 the charging means 3 is a contact charging means making use of a charging roller or the like, the pre-exposure is not necessarily required.

As the combination of the above first color to fourth color, what is common is the combination of yellow, magenta, cyan and black.

The present invention is described below in greater detail by giving Examples.

### EXAMPLE 1

A dope composed of the following was prepared first.

| | (by weight) |
|---|---|
| Poly(para-phenyleneterephthalamide) (TWARON, trade | 6.0% |
| name; available from Teijin Twaron BV) | |
| KETJEN BLACK (trade name: EC600; available from Lion | 0.9% |
| Corp.; particle diameter: 40 nm) | |
| N-methylpyrrolidone | 90.0% |
| Water | 0.8% |
| Calcium chloride | 2.3% |

Next, the above dope was treated by means of an ultrasonic homogenizer, and, after the treatment, passed through a filter in order to remove particles having agglomerated.

Meanwhile, a cylindrical form of 215 mm in outer diameter, made of stainless steel, and a holding jig capable of moving the form in the generatrix direction (axial direction) of a cylinder was readied in order to obtain a tubular product by a dip coating method.

Next, the form was immersed in the dope and thereafter this was drawn up at a constant rate to make the form coated on its peripheral surface with the dope in a tubular shape.

Next, the form having been coated on the peripheral surface thereof with the dope was immersed in 20° C. pure water for 8 hours or more to remove the solvent sufficiently. As a result of the solvent removal, the dope with which the form was coated on its peripheral surface came into an endless (i.e., seamless) tubular product standing wet.

Next, this form was taken out of the pure water, and then the endless tubular product standing wet was taken off from the form. This was anew fitted on a vinyl chloride pipe of 210 mm in outer diameter, followed by drying at 60° C. for 1 hour. Thus the endless tubular product which had stood wet came to stand dry.

After the drying, the endless tubular product standing dry was taken off from the vinyl chloride pipe to obtain a semiconductive endless belt of 100 μm in wall thickness and 210 mm in inner diameter. This semiconductive endless belt had a volume resistivity of 8×10⁸ Ωcm.

### EXAMPLE 2

A semiconductive endless belt was obtained in the same manner as in Example 1 except that, in Example 1, the carbon black of 40 nm in particle diameter which was used in preparing the dope was changed for carbon black of 300 nm in particle diameter. This semiconductive endless belt had a volume resistivity of 5×10⁸ Ωcm.

### COMPARATIVE EXAMPLE 1

To polyethylene terephthalate (trade name: PA200; available from Mitsubishi Rayon Co., Ltd.), KETJEN BLACK (trade name: EC600; available from Lion Corp.; particle diameter: 40 nm) was added in an amount of 10% by weight based on the weight of the former, and these were kneaded. After the kneading, the kneaded product obtained was extruded into a sheet to obtain a sheet of 100 μm in thickness.

Next, the sheet obtained was disposed between two cylindrical forms (an inner form and an outer form) having different coefficients of thermal expansion, at their position where the ends of the sheet substantially joined each other. After thus disposed, the whole sheet and cylindrical forms were heated to obtain a semiconductive endless belt. A method of producing this endless belt is the method disclosed in Japanese Patent No. 3441860. Also, this semiconductive endless belt had a volume resistivity of 5×10⁸ Ωcm.

### COMPARATIVE EXAMPLE 2

3,3′,4,4′-Biphenyltetracarboxylic acid dihydrate and 4,4′-diaminodiphenyl ether were allowed to react in an N-methylpyrrolidone solvent to prepare a polyimide precursor solution.

Next, to the polyimide precursor solution prepared, KETJEN BLACK (trade name: EC600; available from Lion Corp.; particle diameter: 40 nm) was added in an amount of 15% by weight based on the weight of the polyimide precursor in the solution, and these were subjected to dispersion treatment by means of an ultrasonic homogenizer to prepare a solution.

After the dispersion treatment, the solution obtained after the dispersion treatment was passed through a filter in order to remove KETJEN BLACK particles having agglomerated.

Meanwhile, a cylindrical form of 215 mm in outer diameter, made of stainless steel, and a holding jig capable of moving the form in the generatrix direction (axial direction) of a cylinder was readied in order to obtain a tubular product by a dip coating method.

Next, the form was immersed in the solution and thereafter this was drawn up at a constant rate to make the form coated on its peripheral surface in a tubular shape, with the solution having been filtered.

Next, the solution with which the form was coated on its peripheral surface was dried at 115° C., and then imide curing reaction was made to take place at 200° C. for 30 minutes and further at 250° C. for 90 minutes, followed by heat treatment at 350° C. for 1 hour. As a result of these drying, imide curing reaction and heat treatment, the solution with which the form was coated on its peripheral surface came into an endless (i.e., seamless) tubular product.

After the heat treatment, the whole form and endless tubular product were cooled, and, after cooled, the endless tubular product was taken off from the form to obtain a semiconductive endless belt of 100 μm in wall thickness and 210 mm in inner diameter. This semiconductive endless belt was one made of a non-thermoplastic polyimide. Also, this semiconductive endless belt had a volume resistivity of 9×10⁸ Ωcm.

### Evaluation

First, the pencil hardness, refractive index, surface roughness Ra and reflectance of the surfaces of the semiconductive endless belts obtained in Examples 1 and 2 and Comparative Examples 1 and 2 were measured. Results obtained are shown in Table 1.

After the above measurement, the semiconductive endless belts obtained in Examples 1 and 2 and Comparative Examples 1 and 2 were each set as an intermediate transfer belt in the electrophotographic apparatus of an intermediate transfer system, and images were continuously reproduced on 100,000 sheets of A4-size paper in an environment of temperature 23° C. and humidity 50% RH. After the images were reproduced on 100,000 sheets, the reflectance of the surface of each semiconductive endless belt were measured. Results obtained are shown in Table 1.

Incidentally, the pencil hardness was measured by the measuring method according to JIS K 5400.

To measure the refractive index, a spectral ellipsometer (trade name: WVASE) manufactured by J.A. Woollam Co., Inc. was used.

To measure the reflectance, a spectrometer (trade name: U4000) manufactured by Hitachi Ltd. was used. The wavelength of the light was set at 900 nm. The incident angle of the light was set at 5°.

To measure the surface roughness Ra, a feeler surface profile analyzer (trade name: SURFCORDER SE-30C) manufactured by Kosaka Laboratory Ltd. was used.

TABLE 1

| | | | | | | Fall in |
|---|---|---|---|---|---|---|
| Before | | | | | | reflectance |
| 100,000-sheet image reproduction | | | | | | due to 100,000 = |
| | | | Surface | | After ditto | sheet image |
| | Pencil | Refractive | roughness Ra | Reflectance | Reflectance | reproduction |
| | hardness | index | (μm) | (%) | (%) | (%) |
| Example: | | | | | | |
| 1 | 3H | 1.75 | 0.06 | 7.7 | 6.2 | 19 |
| 2 | 3H | 1.75 | 0.10 | 7.2 | 6.0 | 17 |
| Comparative | | | | | | |
| Example: | | | | | | |
| 1 | B | 1.50 | 0.06 | 4.1 | 1.8 | 56 |
| 2 | H | 1.70 | 0.03 | 6.6 | 4.5 | 32 |

In Comparative Example 1, in contrast with Examples 1 and 2, the reflectance is as low as 4.1% before the 100,000-sheet image reproduction, and also, because of a low surface hardness, the fall in reflectance due to 100,000-sheet image reproduction is as very great as 56%. In Comparative Example 2, although the reflectance has come to 6.6% before the 100,000-sheet image reproduction, the fall in reflectance due to 100,000-sheet image reproduction has come to 32%, and, after the 100,000-sheet image reproduction, the reflectance of 6% or more has no longer been maintainable.

As described above, according to the present invention, it can provide at a relatively low cost a semiconductive endless belt which has a surface having high wear resistance and scratch resistance, has a surface having high reflectance, and may undergo small changes with time in respect of this reflectance, and an electrophotographic apparatus having such a semiconductive endless belt.

This application claims priority from Japanese Patent Application No. 2004-358100 filed on Dec. 10, 2004, which is hereby incorporated by reference herein.

What is claimed is:

1. A semiconductive endless belt comprising a resin composition containing a resin capable of being formed into a film only by removing a solvent from a resin solution, and having a pencil hardness of 3H or more according to JIS K 5400 and a refractive index of 1.75 or more for light having a wavelength of 900 μm.

2. The semiconductive endless belt according to claim 1, wherein said resin capable of being formed into a film only by removing a solvent from a resin solution is an aromatic thermoplastic resin.

3. The semiconductive endless belt according to claim 2, wherein said thermoplastic resin is a polyamide resin.

4. The semiconductive endless belt according to claim 1, wherein said resin composition further contains a conductive filler.

5. The semiconductive endless belt according to claim 4, wherein said conductive filler is carbon black.

6. The semiconductive endless belt according to claim 1, which has a volume resistivity of 1×10¹¹ Ωcm or less.

7. The semiconductive endless belt according to claim 6, wherein said volume resistivity is 1×10⁹ Ωcm or less.

8. The semiconductive endless belt according to claim 1, which has a surface roughness Ra of 1.0 μm or less.

9. An electrophotographic apparatus comprising comprises a semiconductive endless belt;
said semiconductive endless belt comprising a resin composition containing a resin capable of being formed into a film only by removing a solvent from a resin solution, and having a pencil hardness of 3H or more according to JIS K 5400 and a refractive index of 1.75 or more for light having a wavelength of 900 μm.

10. The electrophotographic apparatus according to claim 9, wherein said semiconductive endless belt is a transfer material transport belt.

11. The electrophotographic apparatus according to claim 9, wherein said semiconductive endless belt is an intermediate transfer belt.
